(19) United States
(12) Patent Application Publication
(10) Pub. No.: US 2016/0132529 A1
(43) Pub. Date: May 12, 2016

(54) SYSTEMS AND METHODS FOR CLOUD SAFE STORAGE AND DATA RETRIEVAL

(71) Applicant: SWISH DATA CORPORATION, WARWICK, NY (US)

(72) Inventor: SOUBIR ACHARYA, PLEASANTVILLE, NY (US)

(21) Appl. No.: 14/997,964

(22) Filed: Jan. 18, 2016

Related U.S. Application Data
(63) Continuation-in-part of application No. 13/104,179, filed on May 10, 2011, now Pat. No. 9,239,840.
Application No. 13/104,179 is a continuation-in-part of application No. 12/766,778, filed on Apr. 23, 2010, now Pat. No. 9,087,066.
(60) Provisional application No. 61/218,419, filed on Jun. 19, 2009.
(60) Provisional application No. 61/176,098, filed on May 6, 2009.
(60) Provisional application No. 61/172,218, filed on Apr. 24, 2009.

(51) Int. Cl. G06F 17/30

(52) U.S. Cl. CPC G06F 17/30235; G06F 17/30203

(57) ABSTRACT

A system manages a file directory containing data that is exposed by a file-server. The system provides a block-device layered on top of a network share that treats the underlying network share as read-only but allows local file-system semantics to operate on top of the network share. The end-result is a virtual disk containing a locally recognizable file-system that can read and write from the perspective of the operating system but where the data is store in the cloud as network shares. The virtual disk appears to be a fully functional local disk with all the expected local disk semantics.

### CROSS REFERENCE TO RELATED DOCUMENTS

The application is a Continuation In Part (CIP) application of and claims priority to U.S. patent application Ser. No. 13/104,179, filed May 10, 2011, entitled “BACKUP MEDIA CONVERSION VIA INTELLIGENT VIRTUAL APPLIANCE ADAPTER,” which is a CIP of and claims priority to U.S. patent application Ser. No. 12/766,778 (now U.S. Pat. No. 9,087,066), filed Apr. 23, 2010, entitled “VIRTUAL DISK FROM NETWORK SHARES AND FILE SERVERS,” which claims priority to U.S. Provisional Patent Application No. 61/172,218, filed Apr. 24, 2009, entitled “VIRTUAL DISKS AND BOOTABLE VIRTUAL DISKS FROM NETWORK SHARES AND FILE SERVERS,” U.S. Provisional Patent Application No. 61/176,098, filed May 6, 2009, entitled “CLOUDSAFE—MULTI-FUNCTION CLOUD STORAGE AND ON-DEMAND WORKPLACE GATEWAY,” and U.S. Provisional Patent Application No. 61/218,419, filed Jun. 19, 2009, entitled “BACKUP MEDIA CONVERSION VIA INTELLIGENT VIRTUAL APPLIANCE ADAPTER.” All of the above patents and applications are incorporated by reference herein for all that the patents and applications teach and for all purposes.

### BACKGROUND

Storage of enterprise data has moved from local storage to networked storage in the cloud. The days of built infrastructure tied to corporate premises are a thing of the past. Businesses are demanding ready-made Information Technology (IT) that service business quickly and seamlessly. However, businesses need the cloud data to be protected and managed. Indeed, some industry segments require data retention for regulatory reasons, and other businesses need to make corporate applications instantly available to remote locations with access to the cloud-stored data. These demands can overwhelm a business' existing IT staff.

### SUMMARY

It is with respect to the above issues and other problems that the embodiments presented herein were contemplated. Embodiments of systems and methods described herein provide disk virtualization where network share data can be stored to cloud storage. A disk virtualization system creates a virtual disk. The virtual disk can appear as a representation of a local disk. The virtual disk has associated metadata that is exposed to the local file system of the computer system. The metadata allows the file data to be stored to the cloud in blocks that may be retrieved later either from the same network or another network or remote location. Each file stored in the network share needs metadata that wraps the file. The metadata wrapper provides the necessary information for the file system to have files exposed via the network share appear as locally-stored files with requisite on-disk structures.

Given a directory containing useful data that is exposed by a file-server either via NFS, CIFS or other file oriented protocol, create a block-device layered on top of the network share that treats the underlying share as read-only but allows local file-system semantics to operate on top. The end-result is a disk containing a locally recognizable file-system like NTFS, or EXT3, etc. (depending on what the operating system is capable of understanding) that is read-write from the perspective of the OS and is a fully functional local disk with all the expected local disk semantics.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation, or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The term “in communication with” as used herein refers to any coupling, connection, or interaction using electrical signals to exchange information or data, using any system, hardware, software, protocol, or format.

The term “virtual” or “virtualization” as used herein refers to a logical representation of some other component, such as a physical disk drive. In other words, the “virtual” component is not actually the same as the physical component it represents but appears to be the same to other components, hardware, software, etc. of a computer system.

The term “disk” as used herein refers to a storage disk or other memory that can store data for a computer system.

The term “cloud” or “cloud computing” as used herein refers to Internet-based computing, whereby shared resources, software, and information are provided to computers and other devices on-demand, like a public utility.

### BRIEF DESCRIPTION OF THE DRAWINGS

The present disclosure is described in conjunction with the appended figures:

FIG. 1 is a block diagram of an embodiment of a disk virtualization system operable to create a virtual disk for a computer system that stores data to a cloud storage;

FIG. 2A is a block diagram of a server that includes a virtualization module;

FIG. 2B is a block diagram of the virtualization module components operable to create a virtual disk;

FIG. 3A is a block diagram of embodiments of data structure communications between a user, the virtual disk, and/or the cloud storage;

FIG. 3B is another block diagram of embodiments of data structure communications between a user, the virtual disk, and/or the cloud storage;

FIG. 3C is a block diagram of embodiments of data structures associated with cloud storage providers;

FIG. 4 is a flow diagram of an embodiment a process for managing data within cloud storage;

FIG. 5 is a flow diagram of an embodiment a process for writing data to the cloud;

FIG. 6 is a flow diagram of an embodiment a process for reading data from the cloud;

FIG. 7 is a flow diagram of an embodiment a process for purging data from the cloud;

FIG. 8 is a flow diagram of an embodiment a process for de-duplicating data in the cloud;

FIG. 9 is a flow diagram of an embodiment a process for resurrecting a alternate personality with data from the cloud;

FIG. 10 is a block diagram of an embodiment of a computing environment;

FIG. 11 is a block diagram of an embodiment of a computer system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the invention. Rather, the ensuing description will provide those skilled in the art with an enabling description for implementing the embodiments. It should be understood that various changes may be made in the function and arrangement of elements without departing from the spirit and scope of the appended claims.

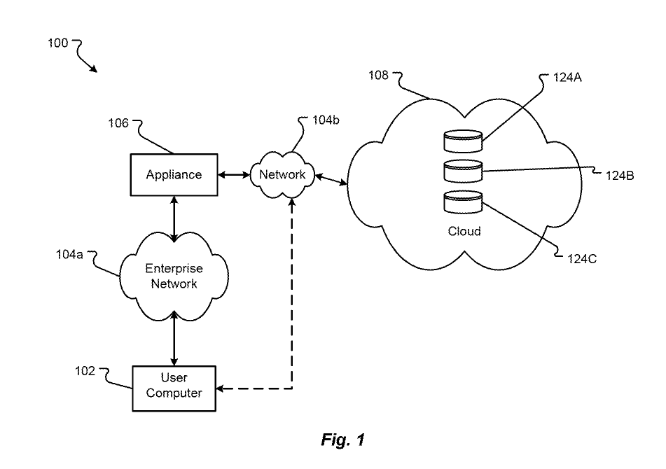

An embodiment of a disk virtualization system 100 for storing data to cloud storage is shown in FIG. 1. A disk virtualization system 100 can create a virtual disk at a server 106 or a user computer 102. The virtual disk can expose network share data, stored in a cloud 108, as a local disk at the server 106 or user computer 102. The disk virtualization system 100 can include one or more components including, but not limited to, a user computer 102, one or more networks 104a and 104b, a server 106, and a cloud 108.

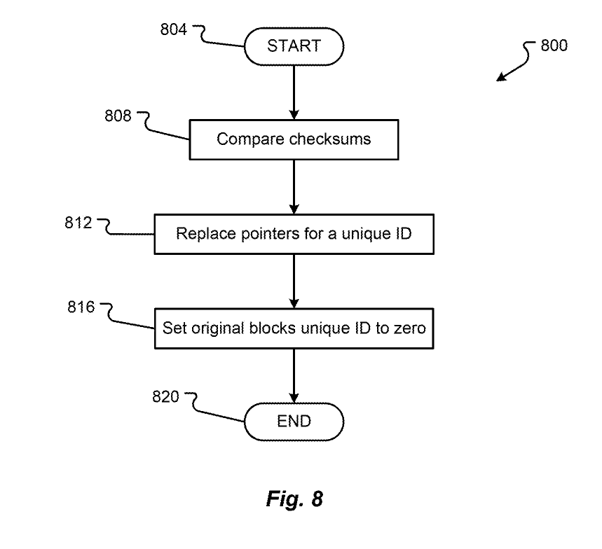

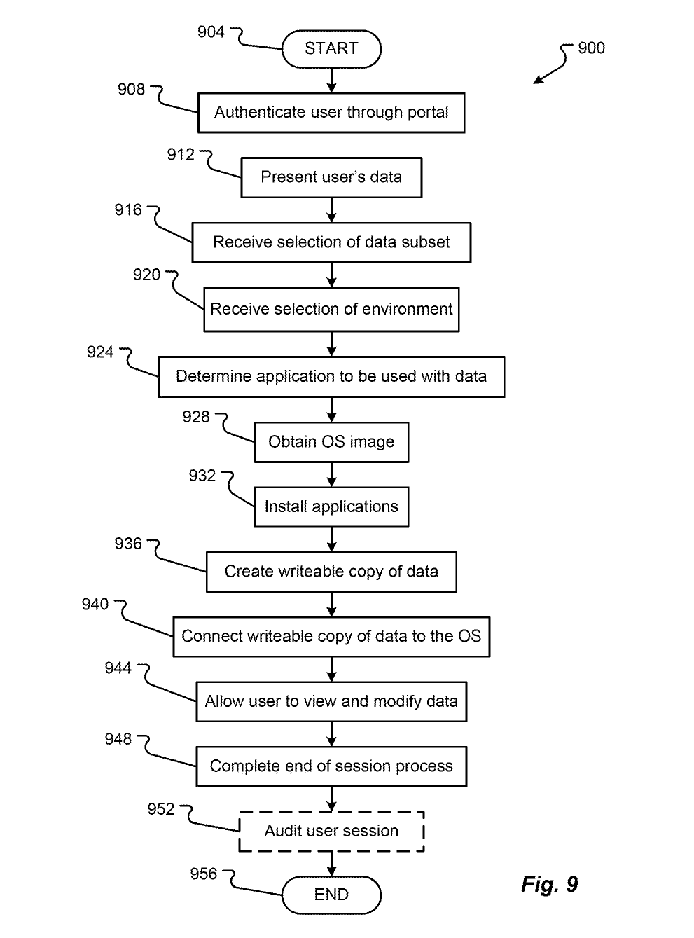

Both the user computer 102 and the server 106 are computer systems such as those described in conjunction with FIGS. 8 and 9. A user computer 102 can be any end user device, such as, a personal computer, a laptop, a mobile device, or some other computer system. A server 106 can also be a computer system, such as those described in conjunction with FIGS. 8 and 9, that stores or shares data with one or more user computers, such as, user computer 102. The server 106 may include one or more storage arrays or disks locally that store data for one or more users.

The server 106 can be physical hardware that resides at the perimeter of the enterprise network 104a and acts as the gateway from the network 104a through network 104b to cloud storage 108. As such, the server 106 can become a backup end-point (target) for the entire enterprise 104a. Once inserted into an enterprise environment, the server 106 (also referred to as an appliance) may inter-operate with existing backup practices while providing secure caching and encrypted offline storage. The enterprise can back up to the appliance 106 and treat the appliance 106 as infinite storage. In some configurations, recently backed up data may be stored and made available locally, on the appliance 106, and can be restored subject to existing enterprise security protocols.

The user computer 102 can be in communication with the server 106 through a network 104a and the server 106 in communication with the cloud 108 through network 104b. A network 104 can be a local area network (LAN), a wide area network (WAN), an intranet, a wireless network, the Internet, etc. The network 104 can function to allow communications between one or more computer systems. The network 104 may communicate in any protocol or format understood by any type of computer system, such as, TCP/IP, RTP, etc. Regardless, the network 104 can exchange communications between a user computer 102, the server 106, and/or the cloud 108.

The cloud 108 represents networked applications and storage that may be executed by one or more systems within a networked environment. The cloud 108 can include one or more servers. In embodiments, the cloud 108 includes a storage system 110. The storage system 110 can be a storage area network (SAN), a disk array, or some other storage that allows the server 106 to store data in the cloud 108 as network shares. Further, the cloud 108 can represent two or more storage providers, such as AMAZON™, NIRVANIX™, etc.

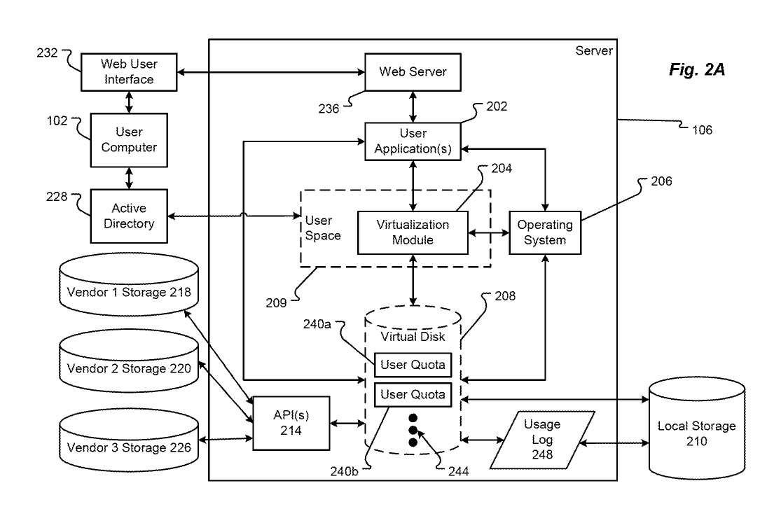

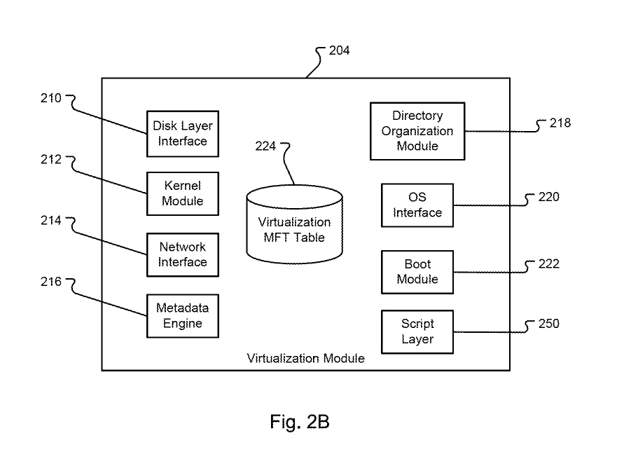

An embodiment of the server 106 is shown in FIG. 2A. The server 106 is shown as having a virtualization module 204 in FIG. 2A. It should be noted that the user computer 102 and/or a server associated with the cloud storage 108 may also include a virtualization module 204, as described herein. As such, the description of FIG. 2A can apply to the server 106, the user computer 102, and/or the cloud 108 shown in FIG. 1. Generally, the server 106 can include one or more user applications 202, the virtualization module 204, an operating system 206, and one or more virtual disks 208.

The one or more user applications 202 can be any software that provides functionality to a user. The user applications 202 can include services or other functions that provide functionality between the server 106 and the user computer 102 and/or between the server 106 and a device connected to the server 106 from a remote location or virtual connection (e.g., a kiosk computer at an airport). User applications are understood in the art and will not be explained further.

The operating system 206 can be any operating system for the server 106, such as, Windows Server or Linux. The operating system 206 controls the execution of processes or user applications 202 and any other functions of the server 106. Operating systems 206 are also well known in the art and will not be explained further.

A virtualization module 204 is operable to create and communicate with a virtual disk 208 and or communicate data to cloud storage 108. The virtualization module 204 can be software executed by the operating system 206 in the server 106. However, in other configurations, the virtualization module 204 may be embodied in hardware, such as an application specific integrated circuit (ASIC) or a field programmable gate array (FPGA). Further, the virtualization module 204 may be a separate function executed by a third party. An embodiment of the virtualization module 204 is shown in FIG. 2B.

The virtual disk 208 can be a logical representation of a physical storage disk, either local to the server 106 or part of the cloud 108, and/or memory exposed to the operating system 206. The virtual disk 208 can include information that directs the server 106 to store and/or obtain file data stored in the cloud 108. The data stored in the cloud 108 can be file data and/or block data that can be read in and returned to operating system 206 or to the user application 202.

A user space 209 refers to the section of virtual memory used to execute user applications. A conventional operating system usually segregates virtual memory into kernel space and user space. Kernel space is reserved for running the kernel, kernel extensions, and most device drivers and user space 209 is the memory area where all user mode applications work and this memory can be swapped out when necessary.

The server 106 may also include or be in communication with local storage 210. Local storage 210 can be any type of storage media as described herein. The storage media may be organized by or be embodied as any type of database or other type of data store as described herein. The local storage 210 can store at least a portion of the data stored in the cloud 110 locally with the server 106 or in the network 104a. Data within the local storage 210 may be duplicated in the cloud 108. If less than all data is stored to the cloud 108, the portion stored within local storage 210 may be data more recently backed up.

One or more application programing interfaces (APIs) 214 may communicate with one or more cloud storage vendors 218, 220, and/or 226. There may be more or fewer cloud storage vendors than those shown in FIG. 2A as represented by ellipses 228. Each API 214 may communicate with a specific cloud storage vendor 218, 220, 226 to exchange data between the API 214 and the vendor 218, 220, 226. The API can translate the data from a format used by the server 106 into a format compliant with the vendor 218, 220, 226. Further, the API can include any routine, protocol, and/or tool that allows the server 106 to store, manage, or retrieve data stored with the vendor 218, 220, 226.

Cloud vendor storage 218, 220, 226 can include any cloud storage provided by a third party or otherwise. The cloud vendor storage 218, 220, 226 may include both the physical data storage and any interface used to interact with the data storage. Examples of the cloud vendor storage 218, 220, 226 can include Amazon cloud storage, Barracuda cloud storage, OneDrive, Dropbox, Google Drive, etc.

The active directory 228 may be the file system or data storage for the users of the network 104a. The active directory may be a file system, for example, NFS, a Linux file system, CIFS, a Microsoft Server file system, etc. Data may be stored to the active directory 228 and then backed up to the virtual disk 208. As such, data stored in the active directory may be stored as files comprising blocks of data.

A web user interface (UI) 232 may also be provided by the server 106. The web UI 232 may execute on the user computer 102 based on executables, hypertext markup language (HTML), extensible markup language (XML), or other code provided or provisioned from a web server 236 executing on the server 106. The web server 236 may be a separate virtual machine operating on the server 106, may be a separate set of hardware within the server 106, or may be a separate device from the server 106 but in communication with the server 106. The web server 236 allows a user 102 to access data within the virtual disk 208 or data stored at one or more vendor cloud storage 218, 220, 226. Thus, the web server 236 may provide application functionality, via the user applications 202, and data when the user remotely connects to the appliance 106 through an extra-enterprise network 104b.

A user quota 240a, 240b can be an allocation of storage on the virtual disk 208. The user quota 240 can be a portion of available space on the virtual disk, where each user is assigned a particular allocation. There may be more or fewer user quotas than those shown in FIG. 2A, as represented by ellipses 244. The user quota 240 may be similar for each user or may differ based on one or more characteristics of the user, for example, the priority of the user, the type of user, the data usage of the user, etc.

A description of the data stored by a user(s), information about how, when, where, etc. of the data storage, and other information may be recorded and stored as usage log 248. The usage log 248 may continual update as data is backed up or stored to the virtual disk 208 local storage 210, andlor vendor storage 218, 220, 224. The usage log 248 may be stored in local storage 210 and replicated to one or more of the vendor storages 218, 220, 224.

An embodiment of the virtualization module 204 is shown in FIG. 2B. The disk layer interface 210 is operable to interface between the virtual disk 208 and the operating system 206 and/or user application(s) 202. The disk layer interface 210 receives read or store requests for data from the operating system 206 and exposes the virtual disk 208 to the operating system 206. As such, the disk layer interface 210 can provide any information or data to the operating system 206 or user application(s) 202 such that the virtual disk 208 appears as a physical disk to the local file system executed by the operating system 206.

A kernel module 212 provides the operational functionality for the virtualization module 204. The kernel module 212 can interface with any other module in the virtualization module 204 to send or receive data. The kernel module 212 can command one or more other interface or modules within the virtualization module 204. Thus, the kernel module 212 can organize, manage, or execute the different functions within the virtualization module 204.

A network interface 214 is operable to communicate between the server 102 and the cloud 108. Thus, the network interface 214 can send or receive data blocks from the cloud 108. Thus, when a file is read into the server 106, the network interface 214 can read in blocks of data for the file and return those blocks of data to the disk layer interface 210 to be sent to the operating system 206 and/or the user application 202. The network interface 214 may communicate with the file system in the cloud which may be network file system (NFS), a Linux file system, Common Internet File System (CIFS), a Microsoft Server file system, or other file system.

A metadata engine 216 can create, modify, store, or retrieve metadata that is used to create the virtual disk and expose the virtual disk to the operating system 206. As such, the metadata engine 210 can create a metadata wrapper for the file system and each file stored within the virtual disk 208. In an embodiment, the file system used by the operating system 206 may be New Technology File System (NTFS), a Windows NT file system, may require a master file table that may be stored in the virtualization master file table database 224. The master file table will be described herein after but one skilled in the art will understand the other metadata that may be required in the “master file table” if another file system is used, such as third extended file system (EXT3), a Linux file system, or another file system. The metadata engine provides the metadata required to expose the virtual disk 208 to the operating system 206.

A directory organization module 218 can provide the data required to give a directory structure to the virtual disk 208. The directory structure provides a root directory and then one or more subdirectories that can organize the files within the virtual disk 208. Thus, the files, stored within the virtual disk 208, are managed similar to an actual physical disk. Further, a hierarchy of directories and files can be exposed to the file system used by the operating system 206.

An operating system (OS) interface 220 can provide the hooks or pointers from the operating system commands to the virtual disk 208. For example, if an operating system attempts to write information to the virtual disk 208, the operating system interface 220 can intercept those commands and provide the commands to the disk layer interface 210 to be executed with the virtual disk 208. Further, any write commands, read commands, or other commands may he intercepted or sent between the virtualization module 204 and the operating system 206 by the operating system interface 220, such that the operating system interface 220 provides the appearance, to the operating system 206, that the virtual disk 208 is an actual physical disk in the local computer system.

A boot module 222 provides the jumps, pointers, links, metadata, and different operating requirements to use the virtual disk 208 as a boot disk. A boot disk is used to boot the server 106 at start-up or during other occasions. The boot module 222 provides the specific functionality for booting the server 102 from the virtual disk 208.

The virtualization module 204 may also include a script layer 250. The script layer 250 can communicate with one or more users 102 to conduct backup operations. Once the appliance 106 is incorporated with the Active Directory 228 in the network 104a, users can upload and/or download files to the appliance 104a using standard network protocols, like CIFS or NFS. The script layer can conduct these data transactions, and the appliance 104 can create a record, in the usage log 248, for audit, history and billing purposes. As data is transferred to the appliance 106, via backup software or manually, the script layer 250 may run an asynchronous schedule that takes ZFS snapshots. Thus, versions of files and backups happen automatically on the appliance 106. A counterpart to the appliance 106 can exist in the cloud 108, which can be created with an identical file-system. Periodically, the script layer can copy the local snapshot, with incremental changes to the remote cloud file system. Thus the cloud appliance will have a second copy of all data. In some configuration all transfers are incremental and encrypted. Further, data in the cloud 108 may be encrypted on the cloud 108.

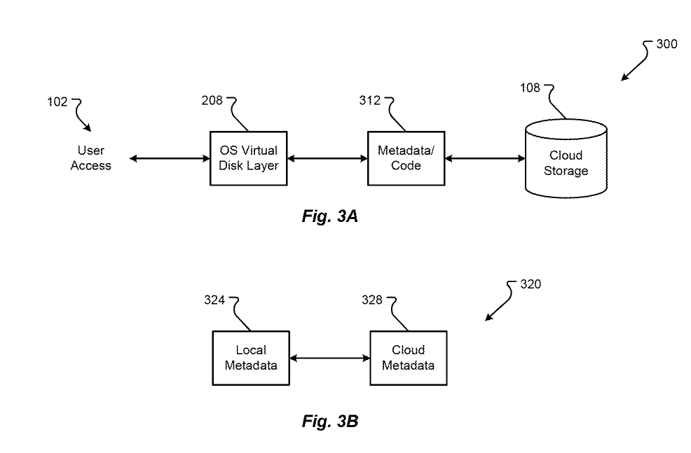

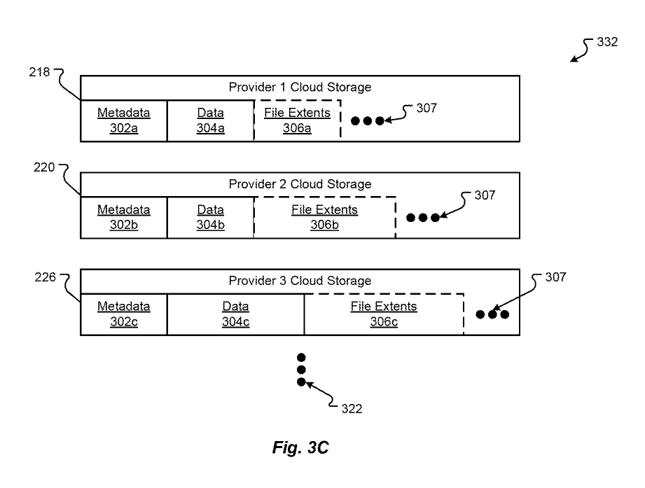

Finally, the virtualization master file table database 224 contains the one or more master file tables that store the metadata created by the metadata engine 216 and used by the one or more other modules or interfaces. The virtualization master file table (MFT) database 224 can be any type of storage or data system that exposes data, stores data, retrieves data, or modifies data for one or more components. The virtualization MFT database 224 can store one or more MFT tables as described in conjunction with FIG. 3.

An embodiment of a data storage process 300 for managing data in the cloud 108 by creating metadata 312 associated with the data is shown in FIG. 3A. The metadata/code data structure 312 can be stored in several different forms or in different types of databases or data storage systems, such as relational databases, flat files, object-oriented databases, etc. Thus, while the term “data field” or segment” is used, the data may be stored in an object, an attribute of an object, or some other form of data structure. Further, at least portions of the metadata/code data structure 312 can be stored, retrieved, sent, or received during the operation of the virtual disk by the server 106 or the user computer 102. The metadata/code data structure 312 stores one or more items of information in one or more data fields. The data in the metadata/code data structure 312 can be as described in conjunction with FIG. 3C. The metadata/code data structure 312 may be generated and/or updated by the server 106 and/ or user 102 during storage of back up data and saved either in the virtual disk 208 and/or the cloud 108.

As is shown in FIG. 3B, there may be duplicate copies of the metadata/code data structure 312 shown as local metadata 324 and/or cloud metadata 328 maintained in a synchronization scheme 320. The local metadata 324 and/or cloud metalata 328 may also be as described in conjunction with FIG. 3C. During storage, the local metadata 324 and/or cloud metadata 328 may be formed and saved in local storage 210 and also in each of the vendor cloud storage 218, 222, 226. Changes to local metadata 324 may be synchronized to update the copies in each of the vendor cloud storage 218, 222, 226 to maintain like copies of the metadata.

The data structure 332 for storing data across the vendor cloud storages 218, 222, 226 may be as shown in FIG. 3C. Each of the vendor cloud storage 218, 222, 226 can include a separate data store having one or more fields, that may include, but is not limited to, metadata 302 (which may be the same or similar to the metadata/code data structure 312), backed up data 304, and/or a file extents 306. There may be more or fewer fields in the data as represented by ellipses 307. Further, there may be more or fewer cloud storage vendors than those shown in FIG. 3C, as represented by ellipses 322.

A separate metadata file 302 may be created and updated. The metadata file 302 may remain both in memory and cached locally 210 as well as cached on all available providers 218, 22, 226. The metadata file 302 can contain the mapping between logical blocks on the device and the location of the blocks within files A-1, B-1, C-1, etc. The first file that is created on each provider 218, 22, 226 may be the metadata file 302. The metadata file 302 can also be created and cached locally in storage 210. In at least some configurations, a memory mapped file is used for the metadata file 302 by the mapping script layer 250 that stores the data into the cloud 108.

As blocks get written to the cloud 108, the server 106 can pack the blocks into available space in the file A-1, B-1, etc. A single block can reside at multiple locations, within and across many providers 218, 22, 226. This storage and duplication is controlled, by the script layer 250, at creation time for both redundancy and performance reasons. As blocks are written, the script layer 250 can pack the blocks sequentially and a densely as possible, until the blocks reach the extent boundary of the storage.

The metadata file 302 can thus include data for a start address, a block length, a unique ID, and/or a checksum. The unique ID may be a computationally unique, monotonically increasing sequence, which is assigned to each write at the end of completion of a single set of sequential writes—although other types of IDs are possible. The unique ID may identify the block or set of blocks written and can tag the block or set of blocks with a sequence number, which can help in determining the write-order. The unique ID may also be constructed with a high granularity timestamp so that the write time for each segment can be determined later. No writes may overwrite any existing writes, older writes can be purged as part of a different process to be described later. The unique IDs may be listed in a separate file called $UNIQUE<id> which can have quintuplets: unique ID, provider, file, start address, and/or write or block length. Unique IDs may be repeated if files are redundantly stored, within and across providers 218, 220, 226.

The checksum is optional and computed efficiently from the in memory write buffer and recorded as part of the metadata file 302. The data 304 includes any blocks written to the providers 218, 220, 226. File extents 306 can include the address or length of available storage capacity in the provider 218, 220, 226.

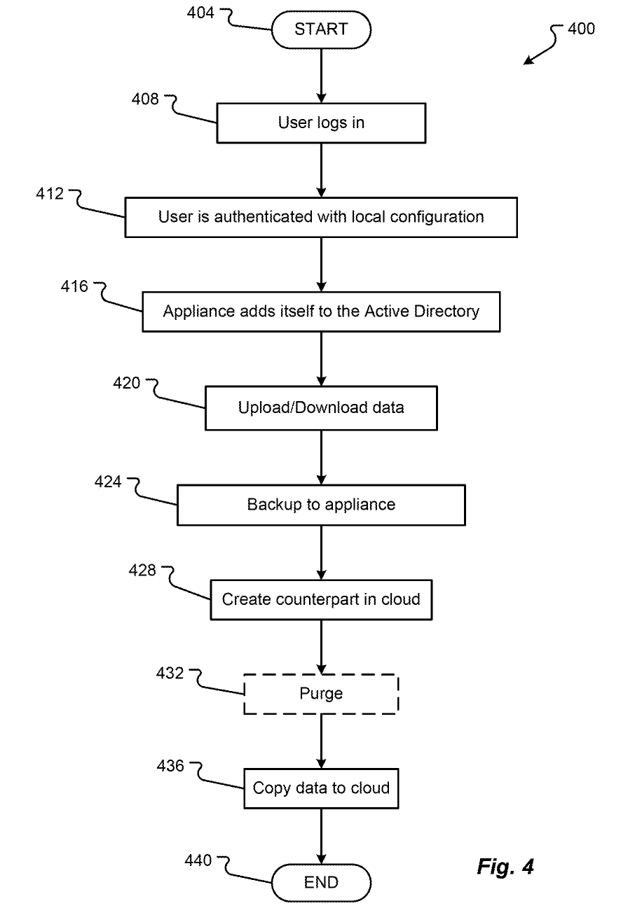

An embodiment of a process or method 400 for creating cloud storage is shown in FIG. 4. Generally, the method 400 begins with a start operation 404 and terminates with an end operation 440. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, software, data structures, etc. described in conjunction with FIGS. 1-3C.

A user computer 102 logins in to the portal of the server 106, in step 408. If it is the first login by a user, that user is identified as a special administrator user and has special privileges and will be allowed to setup and configure the appliance 106. Generally, the user 102 can login through the user space 209 or the web server 236 via a web UI 232.

The server 106 may then authenticate the user against the Active Directory 228, in step 412. If the user is registering, a script layer 250 can execute, on the web server 236, a script to create a user account, a user quota 240 (space) inside the appliance 106, and a full local configuration for the user.

The appliance 106 may then add itself as a member of the local network 104a with a domain account (with domain join rights) using the available corporate Active Directory 104a/228, in step 416.

Once the appliance 106 is part of the Active Directory network 104a/228, authenticated users may upload and/or download files to the appliance 106 using standard network protocols, like CIFS or NFS, in step 420. As these transactions take place within the appliance 106, a usage record 248 is made for audit, history, and/or billing purposes.

As data is transferred from the user 104 to the appliance 106, via backup software or manually, the script layer 250 runs an asynchronous schedule taking ZFS snapshots, in step 424. Thus, versions of files and backups can happen automatically on the appliance 106.

An appliance counterpart may exist in the cloud 108, which can be created with an identical file-system, in step 428. Periodically, the local appliance snapshot would copy incremental changes to the remote ‘cloud’ appliance 108. Thus, the cloud appliance 108 can have a second copy of all data. The transfers can be incremental and encrypted. Further, the data can also be stored as encrypted data on the remote appliance 108.

In some configurations, the script layer may execute a purge script periodically to remove older snapshots from the local appliance to free up space, in step 432. The purge script may make sure that the corresponding snapshot exists on the cloud appliance 108.

Further, the server 106 or cloud appliance 108 also copy data “sideways” or duplicate data to other remote storage vendors 218, 222, 226, like Microsoft and Nirvanix to create automatic copies of data between providers, in step 436.

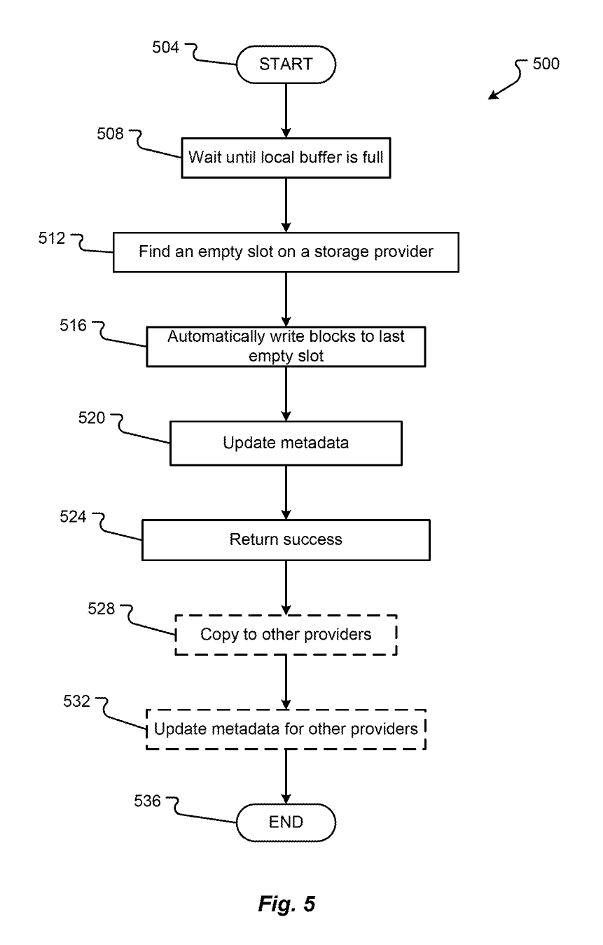

An embodiment of a process or method 500 for writing data to the cloud is shown in FIG. 5. Generally, the method 500 begins with a start operation 504 and terminates with an end operation 536. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, software, data structures, etc. described in conjunction with FIGS. 1-4.

The disk layer interface 210 can wait until a local buffer is full or an idle write timeout is reached, in step 508 The script layer 250 may then find an empty slot on a randomly selected storage provider 218, 222, 226, by looking at last extent written 306 (the last extent written may be updated as part of a write), in step 512. The script layer 250 may then automatically write blocks to the end of the last empty slot, in step 516.

The metadata engine 216 may then update the metadata file 302 and unique ID file, in step 520, for the provider 218, 222, 226 to which data was written. The script layer 250 can then return success to the virtual disk layer 210, in step 524.

The script layer 250 may also determine if redundancy is required for the data. If redundancy is required, then the script layer can write asynchronously from the main writing thread to as many other storage providers 218, 222, 226, as required by the redundancy level, in optional step 528. Further, the metadata engine 216 may also optionally update metadata 302 and unique IDs for each redundant provider 218, 222, 226, in step 532.

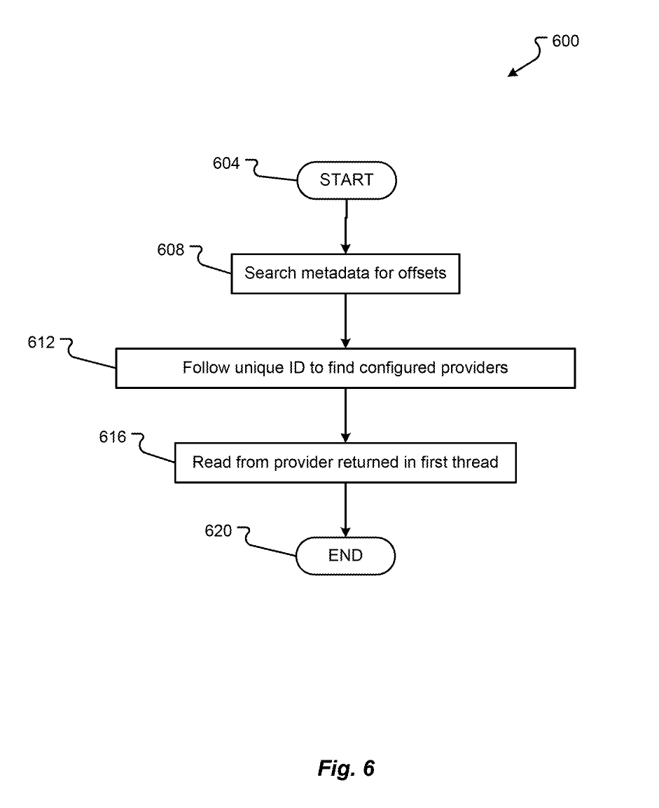

An embodiment of a process or method 600 for reading from cloud storage is shown in FIG. 6. Generally, the method 600 begins with a start operation 602 and terminates with an end operation 616. While a general order for the steps of the method 600 are shown in FIG. 6, the method 600 can include more or fewer steps or arrange the order of the steps differently than those shown in FIG. 6. The method 600 can be executed as a set of computer-executable instructions executed by a computer system and encoded or stored on a computer readable medium. Hereinafter, the method 600 shall be explained with reference to the systems, components, modules, software, data structures, etc. described in conjunction with FIGS. 1-5.

A metadata engine 216 or other module can search metadata 302 (which is memory mapped and sorted by offsets) for matching offset(s) associated with blocks in a file, in step 608. The metadata engine 216 may then follow the unique ID found in the search to find the unique IDs on all configured providers 218, 222, 226 substantially simultaneously, in step 612. In some configurations, the search is optimized by first finding the largest unique ID by going to the end of the file. Since unique IDs can be monotonically increasing, if a unique ID being searched is greater than the last unique ID in a file, this situation indicates that a next unique ID file needs to be searched.

Whichever search thread returns first from a provider 218, 222, 226, the script layer 250 determines the provider, file, start, length, and the other threads are terminated. A read is then initiated from the designated provider, file, offset for the required length, in step 616. The search process can also be initiated with a time range as input, in which case, all unique IDs in that range are returned. This type of search allows for block versioning and needs file-system or layered driver support to present versions or snapshots to the user layer.

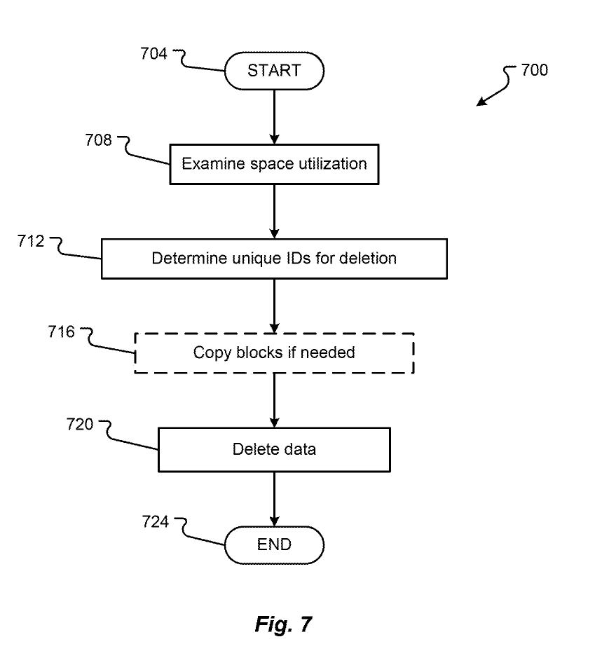

An embodiment of a process or method 700 for purging cloud data is shown in FIG. 7. Generally, the method 700 begins with a start operation 704 and terminates with an end operation 724. While a general order for the steps of the method 700 are shown in FIG. 7, the method 700 can include more or fewer steps or arrange the order of the steps differently than those shown in FIG. 7. The method 700 can be executed as a set of computer-executable instructions executed by a computer system and encoded or stored on a computer readable medium. Hereinafter, the method 700 shall be explained with reference to the systems, components, modules, software, data structures, etc. described in conjunction with FIGS. 1-6.

A periodic purge process can runs on the cloud data (at a lower priority than read and write threads), where a script layer thread can examine space utilization against space utilization thresholds on each provider, in step 708. Here, the script determines if that amount of space being used is approaching the maximum allotted space or some other benchmark. The thread from the script layer 250 then examines the unique ID files that are candidates for deletion of blocks, in step 712. No blocks are deleted if there is no advance copy of data for that block, i.e. , the same block has a larger unique ID. If all segments of a file on a device 106 is found marked for deletion, the entire file may be deleted and the unique ID file updated to reflect the changes. Unique ID entries can have the length attribute set to zero if the entry has been purged, to indicate it as a stale unique ID.

Potentially, over time, there will be files which have “holes” (blocks stored in sectors or areas that are not continuous) but cannot be deleted because the file contains some unique ID which has not changed since the data was written and no redundant copy for that block exists. In this situation, the small set of blocks that have to preserved can be copied to the latest file on the provider 106 (with a new unique ID pointing to the copied version of data), and the script layer thread 250 can delete the old provider file in its entirety, in optional step 716. After determining which blocks to delete, the script layer thread 250 can purge or delete the identified or marked blocks, in step 720. The unique ID files themselves may be candidates for removal as entries get stale and can be deleted in their entirety when all entries are stale or when most entries are stale and the remaining entries are copied up to a newer unique ID file.

An embodiment of a process or method 800 for de-duplicating cloud data is shown in FIG. 8. Generally, the method 800 begins with a start operation 804 and terminates with an end operation 820. While a general order for the steps of the method 800 are shown in FIG. 8, the method 800 can include more or fewer steps or arrange the order of the steps differently than those shown in FIG. 8. The method 800 can be executed as a set of computer-executable instructions executed by a computer system and encoded or stored on a computer readable medium. Hereinafter, the method 800 shall be explained with reference to the systems, components, modules, software, data structures, etc. described in conjunction with FIGS. 1-7.

A thread in the script layer 250 can also complete efficient de-duplication as part of the purge process. The thread can compare checksums between two or more files or blocks during an examination process, in step 808. If two files or blocks with identical checksums are located, the thread can replace the provider, file, start, length, pointed to by a unique ID, by another unique ID set with identical checksum, in step 812. Then, the thread can set to zero the original block's unique ID, which renders the original block an automatic candidate for deletion during further purging.

An embodiment of a process or method 900 for resurrecting an alternate personality with cloud data is shown in FIG. 9. Generally, the method 900 begins with a start operation 904 and terminates with an end operation 956. While a general order for the steps of the method 900 are shown in FIG. 9, the method 900 can include more or fewer steps or arrange the order of the steps differently than those shown in FIG. 9. The method 900 can be executed as a set of computer-executable instructions executed by a computer system and encoded or stored on a computer readable medium. Hereinafter, the method 900 shall be explained with reference to the systems, components, modules, software, data structures, etc. described in conjunction with FIGS. 1-8.

Existing user data available via the appliance 106 may be presented to users who are authenticated and are valid users of the data via a combination of, for example, hypervisor+JEOS+applications+userdata. JEOS refers to an open source which contains just enough as code to run the set of applications which would be able to interpret and present the data to the end-user for active use. For example, the simplest case of a user wanting a version of an Excel file from Thursday that he wants to work on, at a remote location away from the network 104a. The user can use a computer or kiosk and enter a self-service portal. From the self-service portal, the user can be presented a copy of Linux+Open Office+the Excel file from Thursday that he needs to work on. The work space can then be saved, discarded, or refreshed with additional data. The changed file may be made permanent or exist as a new version.

A server 106 receives a connection from a user computer 102 through a web server 236 in communication with a web UI 232, in step 908. The web server 236 functions as a portal to allow the user computer 102 to authenticate itself with the server 106. After authentication, the user space 209 presents the user's data to the user through the web server 236, in step 912. The user space 209 can receive a selection of a subset of the data and any requests activation through the web server 236, in step 916.

If activation is received, the user space 209 may then receive a choice of execution environment from the user computer 102, in step 920. The user has the option of running an application on a local hypervisor (available on the kiosk, temporary workstation, or personal laptop), on a pay-as-you-go cloud workstation, or on the appliance 106 itself.

Upon selection of the environment, the activation process starts to determine which application to use with the data, in step 924. The data is examined to determine which open-source applications could best serve the data. A catalog is kept of associations between file types and applications. (This is refreshed periodically from the internet database of mime-types etc.)

The user space 209 may then obtain an open source as an image from the catalog which is most compatible with the application, in step 928. In at least some configurations, both the compatibility matrix and open source OS are periodically examined by searching the Internet to determine the best match between application and OS image. Further, an operator could mediate this process periodically and/or, manually to super cede or fine tune the automatic selection process. The user space 209 may then automatically install the application or set of applications on the OS, in step 932. (The installation process may be optimized by examining a local cache within the appliance 106 which contains a least recently used OS+application combination. If a cache hit occurs, the image can be used as is.)

The user space may create or receive a writeable copy of user data-set by invoking an available copy-on-write technology, in step 936. The writeable copy of user-data may then be connected, by the user space 209, to the OS image, as a remote file-system, in step 940. Since the OS image could be running remotely or co-located, the connection prevents delays or errors in using the data.

The user computer 102 or appliance 106 may then execute, view, or modify the application, OS, and/or data locally on the hypervisor available on the appliance 106, or as streamed to a workstation that the user has initiated the session from, or from a remote execution platform like Amazon AWS or Windows Azure, in step 944. The last execution plan requires bundling and copying the image to a remote store. The bundling is very quick since the image contains just enough OS+executables and is small in size.

The user can now view and modify the data during the session. Upon ending the session, the user computer 102 and/or appliance can complete an end-of-session process, in step 948. At the end of the session, the user can email the document, save the session for a fixed number of days, persist the changed version of data, or discard the session completely. In some configurations, the entire user session can be audited to very exacting detail and the audit trail made available by administrators using the appliance, in step 952.

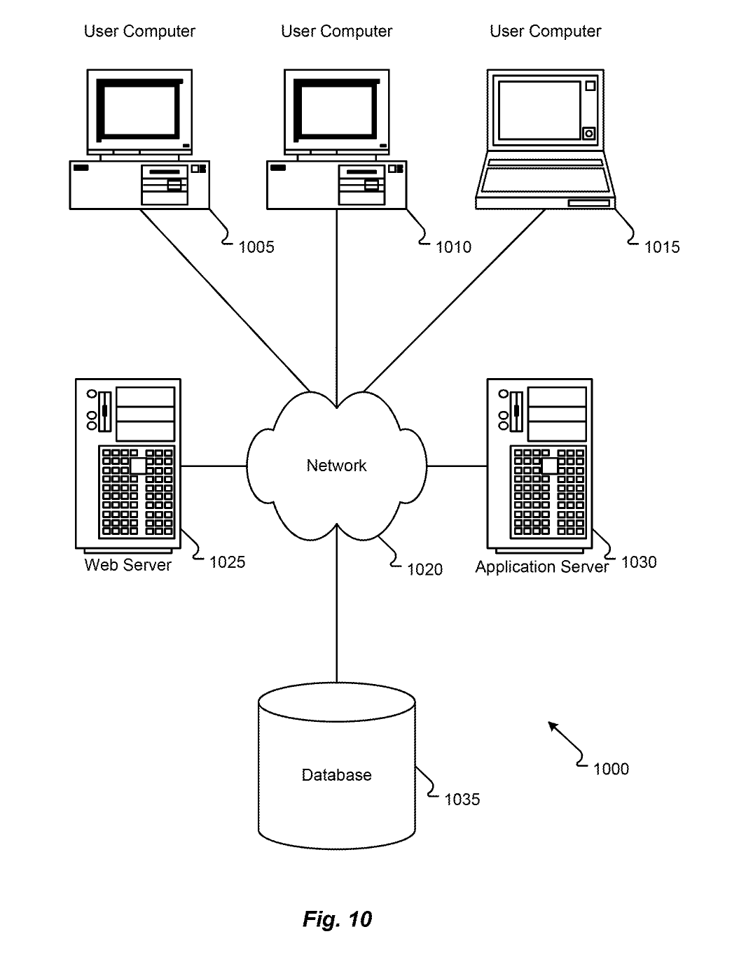

FIG. 10 illustrates a block diagram of a computing environment 1000 that may function as the servers, user computers, or other systems provided and described above. The environment 1000 includes one or more user computers 1005, 1010, and 1015. The user computers 1005, 1010, and 1015 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 1005, 1010, 1015 may also have any of a variety of applications, including for example, database client and/or server applications, and web browser applications. Alternatively, the user computers 1005, 1010, and 1015 may be any other electronic device, such as a thin-client computer, Internet-enabled mobile telephone, and/or personal digital assistant, capable of communicating via a network 1020 and/or displaying and navigating web pages or other types of electronic documents. Although the exemplary computer environment 1000 is shown with three user computers, any number of user computers may be supported.

Environment 1000 further includes a network 1020. The network 1020 may can be any type of network familiar to those skilled in the art that can support data communications using any of a variety of commercially-available protocols, including without limitation SIP, TCP/IP, SNA, IPX, AppleTalk, and the like. Merely by way of example, the network 1020 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server 1025, 1030. In this example, server 1025 is shown as a web server and server 1030 is shown as an application server. The web server 1025, which may be used to process requests for web pages or other electronic documents from user computers 1005, 1010, and 1015. The web server 1025 can be running an operating system including any of those discussed above, as well as any commercially-available server operating systems. The web server 1025 can also run a variety of server applications, including SIP servers, HTTP servers, FTP servers, CGI servers, database servers, Java servers, and the like. In some instances, the web server 1025 may publish operations available operations as one or more web services.

The environment 1000 may also include one or more file and or/application servers 1030, which can, in addition to an operating system, include one or more applications accessible by a client running on one or more of the user computers 1005, 1010, 1015. The server(s) 1030 and/ or 1025 may be one or more general purpose computers capable of executing programs or scripts in response to the user computers 1005, 1010 and 1015. As one example, the server 1030, 1025 may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 1030 may also include database servers, including without limitation those commercially available from Oracle, Microsoft, Sybase™, IBM™ and the like, which can process requests from database clients running on a user computer 1005.

The web pages created by the server 1025 and/or 1030 may be forwarded to a user computer 1005 via a web (file) server 1025, 1030. Similarly, the web server 1025 may be able to receive web page requests, web services invocations, and/or input data from a user computer 1005 and can forward the web page requests and/or input data to the web (application) server 1030. In further embodiments, the web server 1030 may function as a file server. Although for ease of description, FIG. 10 illustrates a separate web server 1025 and file/application server 1030, those skilled in the art will recognize that the functions described with respect to servers 1025, 1030 may be performed by a single server and/or a plurality of specialized servers, depending on implementation-specific needs and parameters. The computer systems 1005, 1010, and 1015, web (file) server 1025 and/or web (application) server 1030 may function as the system, devices, or components described in FIGS. 1-3C.

The environment 1000 may also include a database 1035. The database 1035 may reside in a variety of locations. By way of example, database 1035 may reside on a storage medium local to (and/or resident in) one or more of the computers 1005, 1010, 1015, 1025, 1030. Alternatively, it may be remote from any or all of the computers 1005, 1010, 1015, 1025, 1030, and in communication (e.g, via the network 1020) with one or more of these. The database 1035 may reside in a storage-area network (“SAN”) familiar to those skilled in the art. Similarly, any necessary files for performing the functions attributed to the computers 1005, 1010, 1015, 1025, 1030 may be stored locally on the respective computer and/or remotely, as appropriate. The database 1035 may be a relational database, such as Oracle 10i™, that is adapted to store, update, and retrieve data in response to SQL-formatted commands.

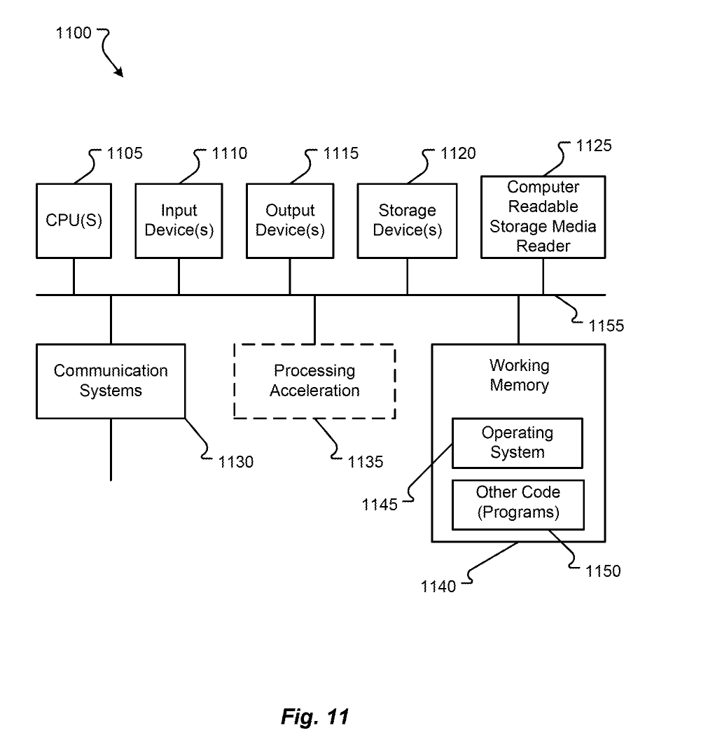

FIG. 11 illustrates one embodiment of a computer system 1100 upon which the servers, user computers, or other systems or components described above may be deployed or executed. The computer system 1100 is shown comprising hardware elements that may be electrically coupled via a bus 1155. The hardware elements may include one or more central processing units (CPUs) 1105; one or more input devices 1110 (e.g., a mouse, a keyboard, etc.); and one or more output devices 1115 (e.g., a display device, a printer, etc.). The computer system 1100 may also include one or more storage devices 1120. By way of example, storage device(s) 1120 may be disk drives, optical storage devices, solid-state storage devices such as a random access memory (“RAM”) and/or a read-only memory (“ROM”), which can be programmable, flash-updateable and/or the like.

The computer system 1100 may additionally include a computer-readable storage media reader 1125; a communications system 1130 (e.g., a modem, a network card (wireless or wired), an infra-red communication device, etc.); and working memory 1140, which may include RAM and ROM devices as described above. The computer system 1100 may also include a processing acceleration unit 1135, which can include a DSP, a special-purpose processor, and/or the like.

The computer-readable storage media reader 1125 can further be connected to a computer-readable storage medium, together (and, optionally, in combination with storage device(s) 1120) comprehensively representing remote, local, fixed, and/or removable storage devices plus storage media for temporarily and/or more permanently containing computer-readable information. The communications system 1130 may permit data to be exchanged with the network 1020 (FIG. 10) and/or any other computer described above with respect to the computer system 1100. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 1100 may also comprise software elements, shown as being currently located within a working memory 1140, including an operating system 1145 and/or other code 1150. It should be appreciated that alternate embodiments of a computer system 1100 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may he performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such Variations, except as limited by the prior art.

What is claimed is:

1. A method for providing a virtual disk that stores data to cloud storage, the method comprising:
providing a computer system including a processor that executes an operating system, wherein the computer system is in communication with a cloud that stores data;
the processor creating a disk layer interface that interfaces between the operating system and the virtual disk;
the processor creating metadata for the operating system to manage block data stored into the cloud storage; and
the processor maintain the metadata locally at the virtual disk and in the cloud storage.

2. The method as defined in claim 1, wherein the file system is one of EXT3 or NTFS.

3. The method as defined in claim 1, wherein the metadata comprises file system metadata and file metadata.

4. The method as defined in claim 3, wherein the file system metadata provides metadata for the file system to interface with the virtual disk.

5. The method as defined in claim 3, wherein the file metadata provides a wrapper for the file data, wherein the wrapper exposes the file data as stored on a local disk, and wherein the wrapper provides a pointer to a network share to retrieve the file data from the cloud.

6. The method as defined in claim 1, further comprising transform a directory structure in the cloud to a directory hierarchy for the file system.

7. The method as defined in claim 1, further comprising:
the processor receiving a read request for data stored on the virtual disk;
the processor triggering a virtual file system layer;
the processor accessing the network share via a pointer stored in the metadata;
the processor reading block data stored in the network share; and
the processor returning the block data as file data.

8. The method as defined in claim 1, further comprising:
the processor receiving new file data to be stored in the virtual disk;
the processor placing the new file data in a local file system cache;
the processor creating metadata for the new file data; and
the processor writing the new file data to the network share.

9. A computer readable medium having stored thereon instructions that cause a computing system to execute a method for interacting with a virtual disk, the instructions comprising:
instructions to receive a read request, for data associated with a file stored on the virtual disk, from an operating system;
instructions to trigger a virtual file system layer, wherein the virtual file system layer exposes block data stored in a network share in a cloud as data stored in a local disk;
instructions to read metadata associated with the file
instructions to access the network share via a pointer stored in the metadata;
instructions to read the block data stored in the network share; and
instructions to return the block data to the operating system as the file.

10. The computer readable medium as defined in claim 9, wherein the metadata comprises file system metadata and file metadata.

11. The computer readable medium as defined in claim 10, wherein the file metadata provides a wrapper for the file data, wherein the wrapper exposes the file data to the operating system as a file stored on a local disk, and wherein the wrapper provides the pointer to the network share to retrieve the block data from the cloud.

12. The computer readable medium as defined in claim 10, wherein the file system metadata provides metadata for the operating system to interface with the virtual disk.

13. The computer readable medium as defined in claim 9, wherein the metadata is stored in a virtual master file table.

14. The computer readable medium as defined in claim 9, further comprising:
instructions to receive new file data to be stored in the virtual disk;
instructions to place the new file data in a local file system cache;
instructions to create new metadata for the new file data; and
instructions to write the new file data to the network share.

15. A server, comprising:
a processor, the processor operable to execute:
an operating system;
a virtual disk, wherein the virtual disk is exposed to the operating system as a local disk, and wherein the virtual disk is operable to store data in a network share on a cloud; and
a virtualization module in communication with the operating system and the virtual disk, the virtualization module operable to expose the virtual disk to the operating system as a local disk.

16. The communication system as defined in claim 15, wherein the virtualization module comprises:
a disk layer interface operable to:
communicate with the operating system;
intercept read requests directed to the virtual disk for a file;
return file data associated with the file in response to the read request;
a network interface in communication with the disk layer interface, the network interface operable to:
receiving the read request;
determine the network share that stores block data associated with the file;
communicate with the network share to read the block data from the network share; and
return the block data to the disk layer interface to be returned as the file data.

17. The communication system as defined in claim 16, wherein the virtualization module comprises a metadata engine operable to:
create file system metadata read by the disk layer interface to expose the virtual disk as a local disk;
create file metadata read by the network interface to determine the network share that stores block data associated with the file.

18. The communication system as defined in claim 17, wherein the metadata engine is operable to store the file system metadata and the file metadata in a virtual master file table.

19. The communication system as defined in claim 18, wherein the virtual master file table comprises:
the file system metadata that comprises:
MFT data;
Secure data;
BITMAP data;
the file metadata that comprises:
a file name:
a pointer to a network share where the block data is stored;
directory structure information; and
permissions information.

20. The communication system as defined in claim 17, further comprising a directory organization module operable to:
determine a directory structure of the block data stored in the network share; and
provide metadata to the metadata engine associated with the directory structure.
